(19) United States
(12) Patent Application Publication
(10) Pub. No.: US 2010/0262458 A1
(43) Pub. Date: Oct. 14, 2010

(54) Inferring an Optimal Minimum Reserve Price from a Distribution of Bids in an Online Auction

(75) Inventors: Michael Schwarz, Berkeley, CA (US); Marcin Mejran, Mountain View, CA (US); Prabhakar Krishnamurthy, Pleasanton, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/422,860

(22) Filed: Apr. 13, 2009

(51) Int. Cl. G06Q 30/00; G06N 5/02; G06Q 10/00

(52) U.S. Cl. 705/10; 705/26; 706/46; 705/400

(57) ABSTRACT

Methods, apparatuses and systems directed to online auctions for keywords used in queries processed by online search engines. Particular implementations of the invention are directed to correlating a distribution of values to a distribution of bids and an optimal minimum reserve price based on historical bid data accumulated as part of producing search results.

### TECHNICAL FIELD

The present disclosure generally relates to ad placement auctions for internet search engines.

### BACKGROUND

Advertising on web pages takes many forms. One method of advertising on the internet involves banner ads displayed on a given web page either on a fixed or rotating basis. This type of advertising could be sold for a flat fee on a “per impression” basis. More recently, internet advertising has increasingly been based on the number of times users click on an ad causing their browser to navigate to the advertiser's web site. This type of advertising is sold on a “per click” basis. The per click form of internet advertising has evolved further as a result of its employment in many popular search engines.

When an internet search engine user requests a search based on a keyword or keywords, a page with general results relating to the keyword or keywords is displayed. The results page generally contains links to web sites with the most relevant content as well as links to sponsored ads related to the keywords entered by the user. The ad content is clearly distinguishable from the general results. Different keywords result in differing ad content. Through this development, an advertiser gained the ability to target advertisements based on keywords rather than paying for an ad that would be shown to all users. Continuing evolution of this idea manifested itself in the form of keyword auctions based on click-through rates.

An advertiser could place bids on keywords and the advertiser's ad placement on a search engine results page would be based on the value of the bid in relation to other bidders in what was known as a “generalized first-price auction.” A higher bid would result in more favorable ad placement. But this mechanism proved to be unstable because advertisers could change their bids at any time and many advertisers began to employ automated “bidding robots” to game the system. The advertiser who could react to its competitors actions more quickly gained a competitive advantage. As a result, some search engine providers adopted a new methodology for auctioning keywords that was less susceptible to instability and gaming.

Another form of auctions called the “generalized second-price” (GSP) auction was introduced, a description of which is available at Edelman, B., Ostrovsky, M., and Schwarz, M., Internet Advertising and the Generalized Second-Price Auction: Selling Billions of Dollars Worth of Keywords, American Economic Review, Volume 97, March 2007. In this type of auction, a winning bidder did not pay the per-click price bid, but rather, paid the per-click price bid by the next highest bidder. Still other types of auction structures have been considered, such as the Vickrey-Clark-Groves mechanism, because they offer more stability. But these more complex types of auction mechanisms have largely been rejected because they are very difficult to explain to users and would entail high transition costs.

### SUMMARY

The present invention provides methods, apparatuses and systems directed to online auctions for keywords used in queries processed by online search engines. Particular implementations of the invention are directed to determining an optimal minimum reserve price for a keyword in online auctions.

Particular implementations of this invention may provide one or more technical advantages. For example, a technical advantage of one implementation may be that a mapping from bid distributions to value distributions in sponsored search advertisement auctions may be used to determine an optimal minimum reserve price.

Particular implementations of the invention may include none, some, or all th above technical advantages. One or more other technical advantages may be readily apparent to one skilled in the art from the figures, descriptions, and claims included herein.

### DESCRIPTION OF THE DRAWINGS

FIG. 1 is a schematic diagram that illustrates an example network environment in which particular implementations of the invention may operate.

FIG. 2 is a schematic diagram illustrating an example computing system architecture that may be used to implement one or more of physical servers.

FIG. 3 is a schematic diagram illustrating a client host environment to which implementations of the invention have application.

FIG. 4 is a functional block diagram illustrating a generalized method for mapping a bid times quality score (BQS) distribution to a value times quality score (VQS) distribution.

FIG. 5 is a functional block diagram illustrating a method for creating VQS distributions from historical BQS distributions.

FIG. 6 is a functional block diagram illustrating a method for determining an optimal minimum reserve price from a VQS distribution.

FIG. 7 is a functional block diagram illustrating a method for creating and mapping a BQS distribution to a VQS distribution.

FIG. 8 is a functional block diagram illustrating a method for determining an optimal minimum reserve price.

### DESCRIPTION OF EXAMPLE EMBODIMENT(S)

### A. Overview

Particular embodiments of the present invention are related to systems that provide preferred ad placement within internet search engine result pages. When an internet user accesses a search page, he or she typically enters a search term, or query, made up of one or more keywords, and initiates a search. A result set is returned containing links to relevant web pages.

In addition to links to relevant content, sponsored advertising may be part of the result set. Ads are typically readily distinguishable from the more generalized search results and are arranged according to some kind of ordered placement scheme. Use of different search terms results in display of a different set of ads. An advertiser may place a different value on specific search terms depending on the relationship of the search terms to the goods and services provided by the advertiser.

Further, an advertiser may place a different value on the location of its ad in the result set in relation to other advertisers. Typically, an advertiser will pay for an ad on a “per click” basis. That is, each time a user clicks on the ad causing the user's browser to navigate to the advertiser's web site, the advertiser will be charged a predetermined amount. More favorable placement of the ad presumably results in a higher “click-through rate” (CTR). The click-through rate is the number of times an ad link is clicked by users of the search engine in a given period of time.

Typically, search engines provide online auction mechanisms to determine ad placement for a given keyword. An advertiser may submit a bid for a particular keyword to so that the advertiser's link will be among the sponsored ads returned by any query involving that keyword. Bids may be entered or changed at any time and will by applied any time a user initiates a search using the advertiser's keyword until the advertiser changes or withdraws the bid. The bid is typically related to what the advertiser will be charged for each click on its ad in the result set. The amount of the bid relative to other advertisers determines the placement of the ad in the result set. That is, a higher bid typically results in more favorable placement than a lower bid.

Some search engines also use a “quality score” to help determine ad placement. In such a scheme, each bid is multiplied by a quality score in order to determine ad placement. The components of a quality score may include factors such as the CTR for a given position in the result set, the relevance of the content of the advertiser's web site to the keywords sold, the overall quality of the advertiser's web site, and/or other relevant factors.

Early search engine keyword auctions followed a generalized first-price auction model. That is, ad placement was determined purely by the advertiser's bid. This mechanism was unstable because it failed to encourage advertisers to bid their true value and it provided an advantage to advertisers that reacted more quickly to other bids. Advertisers could employ bidding robots and other devices to game the system, resulting in less revenue for the search engine.

The generalized second-price (GSP) auction was later introduced by some search engine providers to combat these instabilities. The GSP mechanism charges the advertiser the lowest amount that the advertiser would have to bid in order to retain his position in the ranking of ads. The GSP mechanism is more stable than the generalized first-price auction and discourages gaming the system in the same ways. But even using the GSP model, advertiser's bids may still be lower than the actual value they are willing to pay for a particular ad placement related to a keyword. To adjust for this reality, a search engine provider needs to be able to determine an optimal minimum reserve price (MRP)—the lowest price for which the search engine provider is willing to sell a particular keyword. The MRP functions as a starting point for all bids. The search engine provider typically has no historical record of advertiser's true values from which to derive an MRP. However, the search engine directly observes the distribution of bids for a given keyword and may have historical data relating to that distribution.

As discussed in more detail below, particular implementations of the invention provide a method for mapping a distribution of bids to a generated distribution of advertiser values. Distributions typically comprise a mean, or average, and a standard deviation. The distributions may be based on bid times quality score (BQS) and value times quality score (VQS). Historical BQS distribution data may be used to derive a set of VQS values.

In a particular implementation, a series of simulated auctions may be executed in order to derive a broader set of BQS distributions mapped to the VQS distributions that were derived from historical BQS data. An important component of the simulated auctions may be an actual or simulated number of bidders assigned to each simulated auction. A particular implementation of the invention may be able to derive an MRP from a distribution of VQS. The related BQS, VQS, MRP, and number of bidders may be stored in a mapping data structure for later use in determining the MRP for an auction. In a particular implementation, historical data may be used to create a BQS distribution in advance or in real time. That BQS distribution may then be used to look up the MRP for a given auction in the mapping data structure.

The present invention can be implemented in a variety of manners, as discussed in more detail below. Other implementations of the invention may be practiced without some or all of specific details set forth below. In some instances, well known structures and/or processes have not been described in detail so that the present invention is not unnecessarily obscured.

A.1. Example Network Environment

Particular implementations of the invention operate in a wide area network environment, such as the Internet, including multiple network addressable systems. Network cloud 60 generally represents one or more interconnected networks, over which the systems and hosts described herein can communicate. Network cloud 60 may include packet-based wide area networks (such as the Internet), private networks, wireless networks, satellite networks, cellular networks, paging networks, and the like.

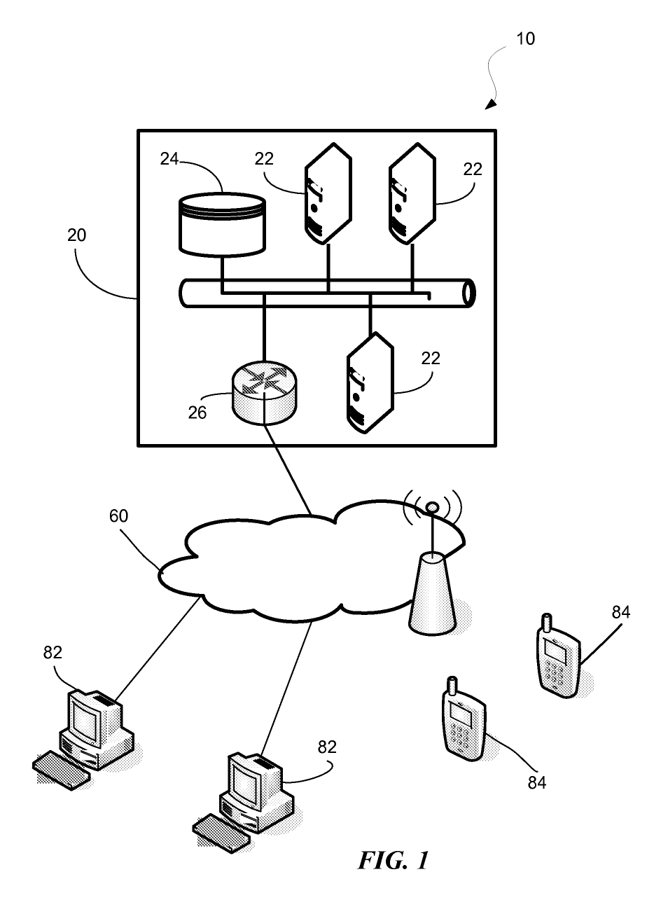

As FIG. 1 illustrates, a particular implementation of the invention can operate in a network environment comprising network application hosting site 20, such as an informational web site, social network site and the like. Although FIG. 1 illustrates only one network application hosting site, implementations of the invention may operate in network environments that include multiples of one or more of the individual systems and sites disclosed herein. Client nodes 82, 84 are operably connected to the network environment via a network service provider or any other suitable means.

Network application hosting site 20 is a network addressable system that hosts a network application accessible to one or more users over a computer network. The network application may be an informational web site where users request and receive identified web pages and other content over the computer network. The network application may also be a search platform, an on-line forum or blogging application where users may submit or otherwise configure content for display to other users. The network application may also be a social network application allowing users to configure and maintain personal web pages. The network application may also be a content distribution application, such as Yahoo! Music Engine®, Apple® iTunes®, podcasting servers, that displays available content, and transmits content to users.

Network application hosting site 20, in one implementation, comprises one or more physical servers 22 and content data store 24. The one or more physical servers 22 are operably connected to computer network 60 via a router 26. The one or more physical servers 22 host functionality that provides a network application (e.g., a news content site, etc.) to a user. In one implementation, the functionality hosted by the one or more physical servers 22 may include web or HTTP servers, ad serving systems, content delivery systems, application servers, and the like. Still further, some or all of the functionality described herein may be accessible using an HTTP interface or presented as a web service using SOAP or other suitable protocols.

Content data store 24 stores content as digital content data objects. A content data object or content object, in particular implementations, is an individual item of digital information typically stored or embodied in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Structurally, content data store 24 connotes a large class of data storage and management systems. In particular implementations, content data store 24 may be implemented by any suitable physical system including components, such as database servers, mass storage media, media library systems, and the like.

Network application hosting site 20, in one implementation, provides web pages, such as front pages, that include an information package or module describing one or more attributes of a network addressable resource, such as a web page containing an article or product description, a downloadable or streaming media file, and the like. The web page may also include one or more ads, such as banner ads, text-based ads, sponsored videos, games, and the like. Generally, web pages and other resources include hypertext links or other controls that a user can activate to retrieve additional web pages or resources. A user “clicks” on the hyperlink with a computer input device to initiate a retrieval request to retrieve the information associated with the hyperlink or control.

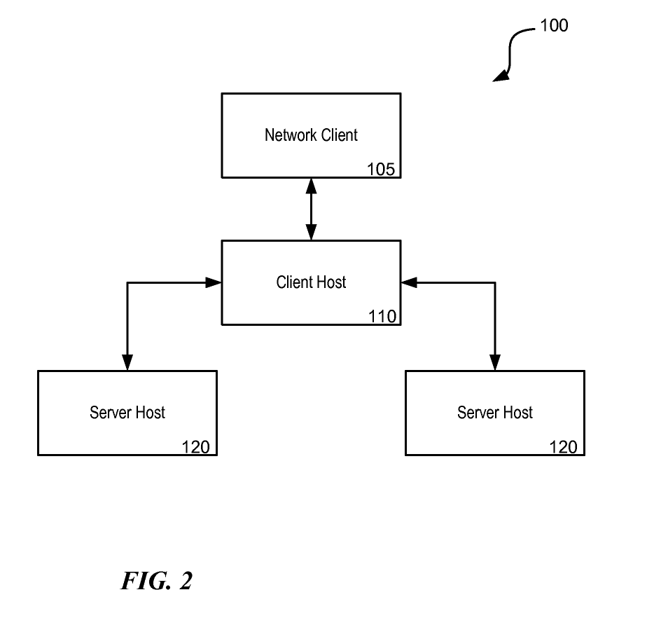

FIG. 2 illustrates the functional modules of a client host server environment 100 within network application hosting site 20 according to one particular implementation. As FIG. 2 illustrates, network application hosting site 20 may comprise one or more network clients 105 and one or more client hosts 110 operating in conjunction with one or more server hosts 120. The foregoing functional modules may be realized by hardware, executable modules stored on a computer readable medium, or a combination of both. The functional modules, for example, may be hosted on one or more physical servers 22 and/or one or more client computers 82, 84.

Network client 105 may be a web client hosted on client computers 82, 84, a client host 110 located on physical server 22, or a server host located on physical server 22. Client host 110 may be an executable web or HTTP server module that accepts HyperText Transport Protocol (HTTP) requests from network clients 105 acting as a web clients, such web browser client applications hosted on client computers 82, 84, and serving HTTP responses including contents, such as HyperText Markup Language (HTML) documents and linked objects (images, advertisements, etc.). Client host 110 may also be an executable module that accepts Simple Object Access Protocol (SOAP) requests from one or more client hosts 110 or one or more server hosts 120. In one implementation, client host 110 has the capability of delegating all or part of single or multiple requests from network client 105 to one or more server hosts 120. Client host 110, as discussed above, may operate to deliver a network application, such as an informational web page or an internet search service.

In a particular implementation, client host 110 may act as a server host 120 to another client host 110 and may function to further delegate requests to one or more server hosts 120 and/or one or more client hosts 110. Server hosts 120 host one or more server applications, such as an ad selection server, sponsored search server, content customization server, and the like.

A.2. Client Nodes & Example Protocol Environment

Client node is a computer or computing device including functionality for communicating over a computer network. A client node can be a desktop computer 82, laptop computer, as well as mobile devices 84, such as cellular telephones, personal digital assistants. A client node may execute one or more client applications, such as a web browser, to access and view content over a computer network. In particular implementations, the client applications allow users to enter addresses of specific network resources to be retrieved. These addresses can be Uniform Resource Locators, or URLs. In addition, once a page or other resource has been retrieved, the client applications may provide access to other pages or records when the user “clicks” on hyperlinks to other resources. In some implementations, such hyperlinks are located within the web pages 30 and provide an automated way for the user to enter the URL of another page and to retrieve that page. The pages or resources can be data records including as content plain textual information, or more complex digitally encoded multimedia content, such as software programs or other code objects, graphics, images, audio signals, videos, and so forth.

The networked systems described herein can communicate over the network 60 using any suitable communications protocols. For example, client nodes 82, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. Still further, in particular implementations, the information transmitted between hosts may be formatted as HyperText Markup Language (HTML) documents. Other structured document languages or formats can be used, such as XML, and the like.

In some client-server protocols, such as the use of HTML over HTTP, a server generally transmits a response to a request from a client. The response may comprise one or more data objects. For example, the response may comprise a first data object, followed by subsequently transmitted data objects. In one implementation, for example, a client request may cause a server to respond with a first data object, such as an HTML page, which itself refers to other data objects. A client application, such as a browser, will request these additional data objects as it parses or otherwise processes the first data object.

Mobile client nodes 84 may use other communications protocols and data formats. For example, mobile client nodes 84, in some implementations, may include Wireless Application Protocol (WAP) functionality and a WAP browser. The use of other wireless or mobile device protocol suites are also possible, such as NTT DoCoMo's i-mode wireless network service protocol suites. In addition, the network environment may also include protocol translation gateways, proxies or other systems to allow mobile client nodes 84, for example, to access other network protocol environments. For example, a user may use a mobile client node 84 to capture an image and upload the image over the carrier network to a content site connected to the Internet.

A.3. Example Computing System Architectures

While the foregoing systems can be implemented by a wide variety of physical systems and in a wide variety of network environments, the client and server host systems described below provide example computing architectures for didactic, rather than limiting, purposes.

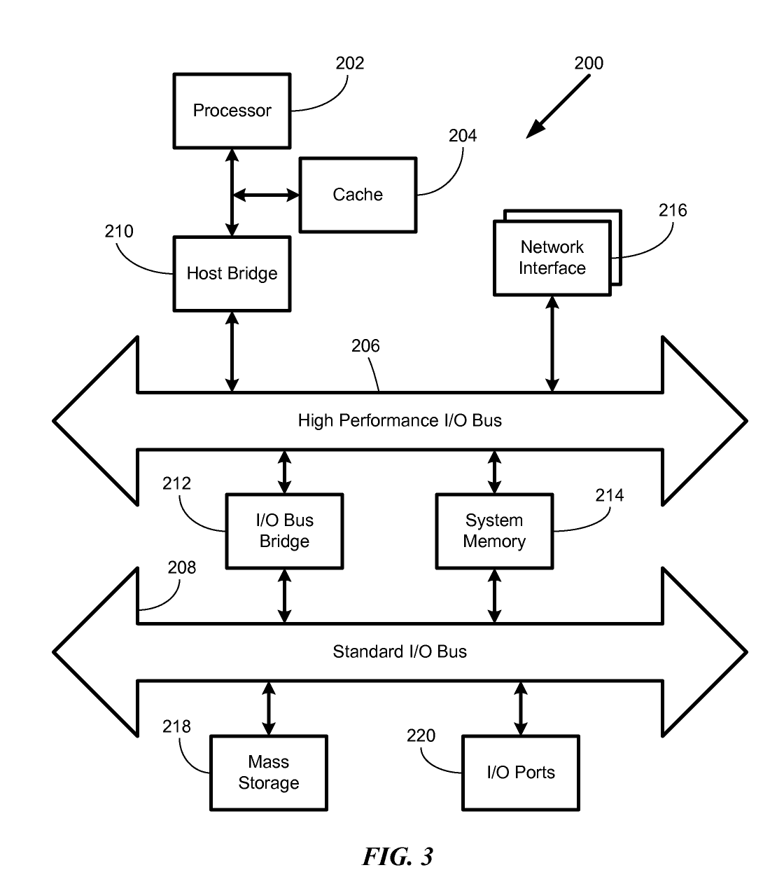

FIG. 3 illustrates an example computing system architecture, which may be used to implement a physical server. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one implementation, the operations of one or more of the physical servers described herein are implemented as a series of software routines run by hardware system 200. These software routines comprise a plurality or series of instructions to be executed by a processor in a hardware system, such as processor 202. Initially, the series of instructions may be stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like. Of course, other implementations are possible. For example, the server functionalities described herein may be implemented by a plurality of server blades communicating over a backplane.

Furthermore, the above-described elements and operations can be comprised of instructions that are stored on storage media. The instructions can be retrieved and executed by a processing system. Some examples of instructions are software, program code, and firmware. Some examples of storage media are memory devices, tape, disks, integrated circuits, and servers. The instructions are operational when executed by the processing system to direct the processing system to operate in accord with the invention. The term “processing system” refers to a single processing device or a group of inter-operational processing devices. Some examples of processing devices are integrated circuits and logic circuitry. Those skilled in the art are familiar with instructions, computers, and storage media.

The present invention has been explained with reference to specific embodiments. For example, while embodiments of the present invention have been described as operating in connection with HTML and HTTP, the present invention can be used in connection with any suitable protocol environment. Furthermore, implementations of the invention can be used in systems directed to serving geo-targeted content other than ads to users. Other embodiments will be evident to those of ordinary skill in the art. It is therefore not intended that the present invention be limited, except as indicated by the appended claims.

A.4. Example Operation

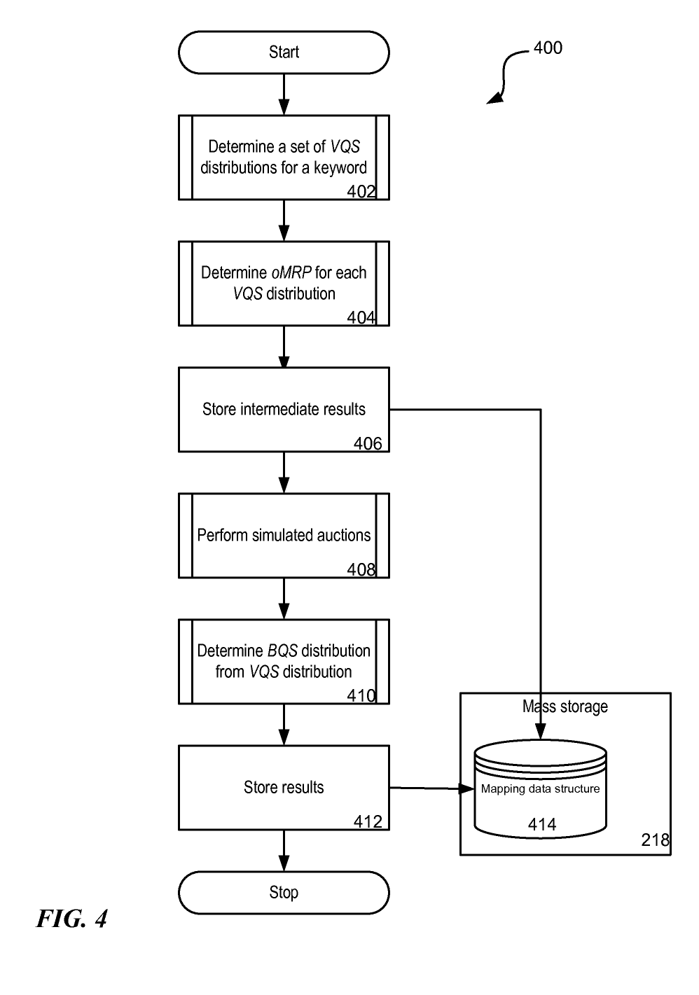

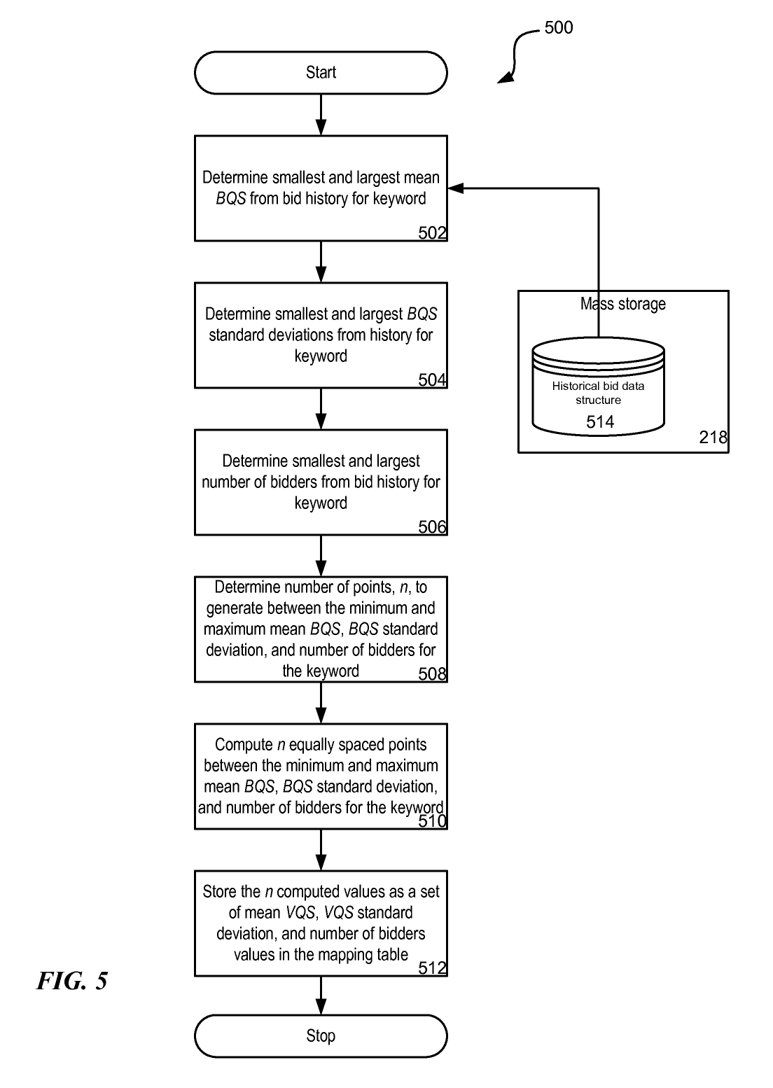

FIG. 4 illustrates an example process 400 that can be implemented by server host 120 to create and store a plurality of mappings of bid times quality score (BQS) distributions to value times quality score (VQS) distributions. As FIG. 4 illustrates, in a particular implementation, server host 120 initiates process 400 which begins by determining one or more of VQS distributions (402). A VQS distribution may comprise the mean, or average, of one or more VQS values and the standard deviation of one or more VQS values. The value may be an amount, or price, an advertiser is willing to pay the search engine provider for a particular ad placement in the result set of a query related to a particular keyword. A quality score (QS) may be a value assigned by the search engine comprising a click-through rate (CTR) for a given position in the result set, the relevance of the content of the advertiser's web site to the keywords sold, the overall quality of the advertiser's web site, and/or other factors. The procedure for determining the set of VQS distributions is discussed in detail below with reference to FIG. 5.

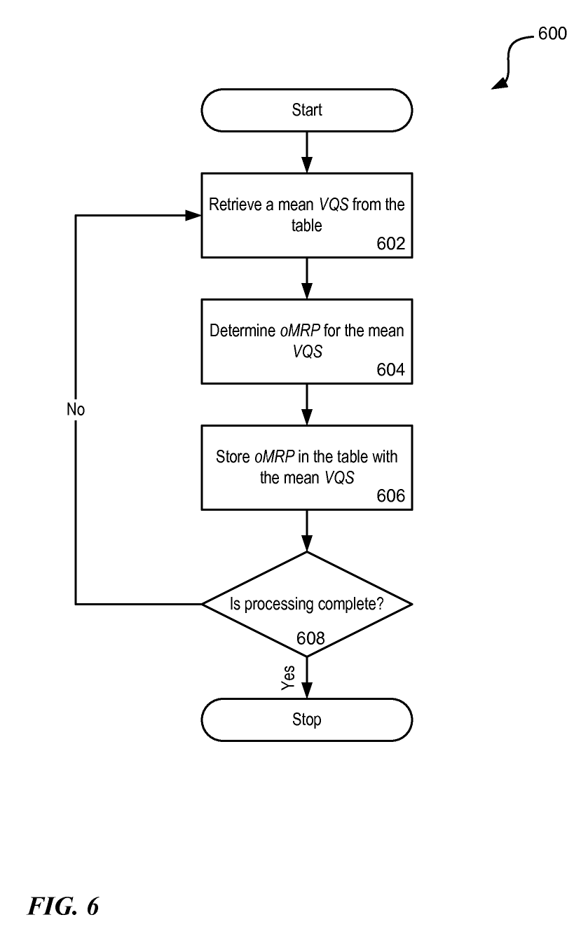

Process 400 continues (404) by determining an optimal minimum reserve price oMRP for each VQS distribution derived in step 402. Optimal minimum reserve price oMRP is a minimum amount an advertiser may bid for a particular keyword. The procedure for determining optimal minimum reserve price oMRP from a VQS distribution is discussed in detail below with reference to FIG. 6. The set of VQS distributions and matching optimal minimum reserve prices oMRPs may be stored (406) to system memory 214 and/or mass storage 218 device. In a particular implementation, the VQS distributions and matching optimal minimum reserve prices oMRPs are stored in mapping data structure 414 on mass storage device 218. Mapping data structure 414 is described in more detail below.

In a particular implementation, a number of simulated auctions are performed (408) using VQS distributions determined in step 402 and optimal minimum reserve prices oMRPs determined in step 404. Each simulated auction may result in calculating one or more BQS values. The one or more BQS values may be used to create a BQS distribution (410) for each VQS distribution determined in step 402. In a particular implementation, the results may be stored in mapping data structure 414 on mass storage device 218 using the following or functionally equivalent table structure, such as a K-D (or K-dimensional) tree:

Mapping Data Structure 414

| Field | Description |
|---|---|
| kw | Keyword |
| mvqs | Mean of VQS |
| svqs | Standard deviation of VQS |
| snb | Simulated number of bidders |
| cmrp | Current minimum reserve price |
| mbqs | Mean of BQS |
| sbqs | Standard deviation of BQS |
| onb | Observed number of bidders |
| omrp | MRP |

FIG. 5 illustrates an example process 500 that can be implemented by server host 120 where the application task to be performed involves determining a set of VQS distributions for a keyword kw. In a particular implementation, process 500 begins by determining a smallest and largest mean BQS, mbqsₘᵢₙ and mbqsₘₐₓ, respectively, (502) for a keyword from bid history table 514. Process 500 continues by determining a smallest and largest BQS standard deviation, sbqsₘᵢₙ and sbqsₘₐₓ, respectively, (504) for a keyword/search from bid history table 514. Process 500 also determines a largest and smallest number of bidders, snbₘᵢₙ and snbₘₐₓ, respectively, (506) for a keyword from bid history table 514. In a particular implementation, bid history table 514 may comprise rows of historical bid data recorded when user queries are processed. Historical bid data structure 816 may comprise rows containing at least a keyword, a bid hb, an advertiser identifier hid, a rank hr, and a date/time stamp ht.

In a particular implementation, a mean BQS mbqs, a BQS standard deviation sbqs, and a number of bidders snb may be calculated for each search in bid history table 514 relevant to keyword kw. Process 500 may create n partitions, or data points, between each of the minimums and maximums (508). In a particular implementation of the invention, an arbitrary value for n, such as 20, may be used or a n may be determined using a formula. The formula may comprise the following:

n=20[2(mbqsₘₐₓ−mbqsₘᵢₙ)][2(sbqsₘₐₓ−sbqsₘᵢₙ)]

Once a value for n is determined (508), process 500 may compute n equally spaced points (510) between each of the three minimums and maximums [mbqsₘᵢₙ, sbqsₘᵢₙ, snbₘᵢₙ] and [mbqsₘₐₓ, sbqsₘₐₓ, snbₘₐₓ]. Each of these points may be a tuple representing a VQS distribution comprising a mean VQS mvqs, a VQS standard deviation svqs, and a number of bidders snb. Process 500 may then store (512) each tuple as a new record in mapping data structure 414. Alternatively, in a particular implementation, each tuple may represent anecdotal data compiled as a predetermined array of data. For example, the following rows may be added to mapping data structure 414:

| Mean BQS | BQS Standard Deviation | Number of Bidders |
|---|---|---|
| (mbqs) | (sbqs) | (snb) |
| 0.05 | 0.01 | 4 |
| 0.01 | 0.04 | 2 |
| 10 | 2 | 40 |

FIG. 6 illustrates an example process 600 that can be implemented by server host 120 where the application task to be performed involves repetition. As FIG. 6 illustrates, in a particular implementation, process 600 begins by retrieving (602) a first mean VQS mvqs written to mapping data structure 414 in step 512 and applying it to a random variable e. In a particular implementation, F(e) is a function that represents the cumulative distribution of random variable e and f(e) is a density function of random variable e. Random variable e is representative of a particular VQS distribution with the mean and standard devision corresponding to a tuple in the mapping data structure. The type of distribution may be log-normal, pareto or triangular. Process 600 determines an MRP omrp (604) by finding the root of a function g(e), where

$$g ( e ) = e - \frac{1 - F ( e )}{f ( e )}$$

In a particular implementation, a standard method may be used to determine the root of g(e) using one or more well known methods. Examples of such methods are the bisection method, the secant method, inverse quadratic interpolation, Dekker's method (which combines the bisection method and the secant method), and/or Brent's method (which combines the bisection method, the secant method, and inverse quadratic interpolation). The root of the function g(e) is the value of e for which g(e)=0 and may represent an omrp for a particular VQS distribution. Once the root of g(e) is determined, it is stored (606) in mapping data structure 414 as omrp in a location related to the mean VQS mvqs upon which it is based. Process 600 then determines whether it has processed all the records from mapping data structure 414 that were created by process 500. If not, process 600 returns to step 602 and repeats then entire procedure for a new mean VQS mvqs. If all the records written to mapping data structure 414 by process 500 have been processed by process 600, process 600 terminates.

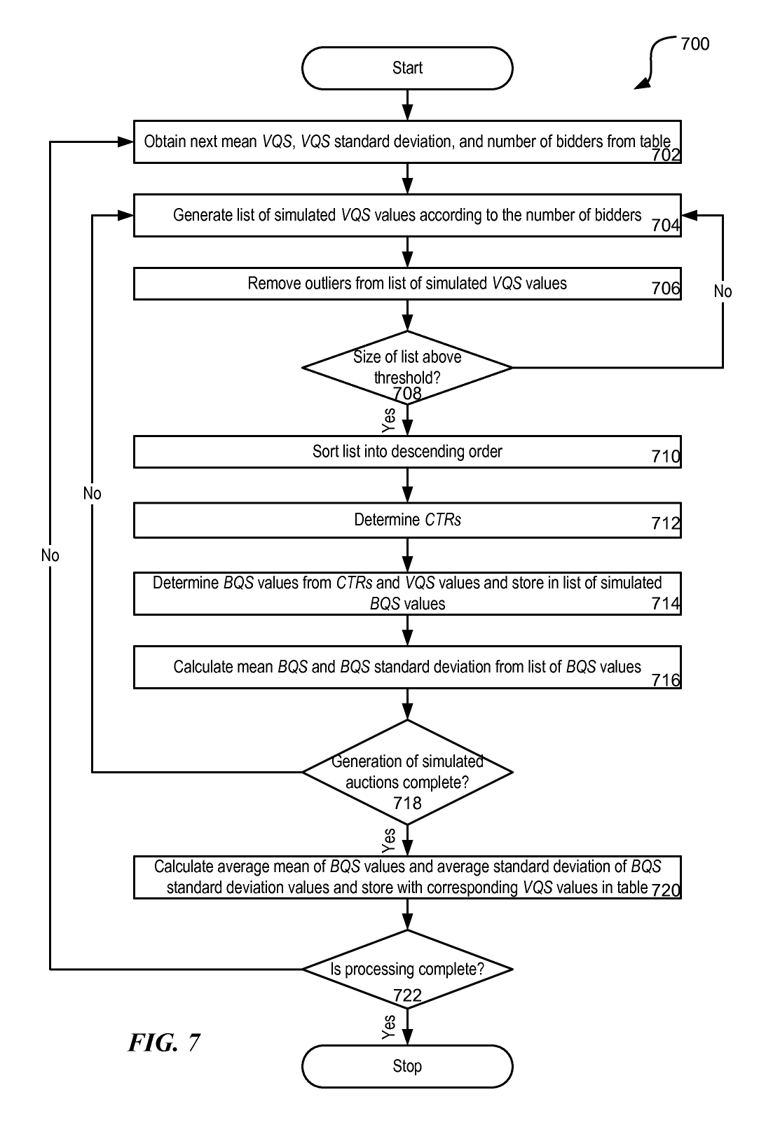

FIG. 7 illustrates an example process 700 that can be implemented by server host 120 where the application task to be performed involves repetition. As FIG. 7 illustrates, in a particular implementation, process 700 begins by retrieving (702) a first VQS distribution, number of bidders, and MRP written to mapping data structure 414 in step 512.

In a particular implementation, process 700 proceeds by performing steps necessary to complete one or more simulated auctions for each VQS distribution written to mapping data structure 414 in step 512. The number of simulated auctions performed may be an arbitrary number, such as 5000, and/or may be calculated using a formula or procedure. Step 704 generates a list of VQS values vt from the VQS distribution retrieved in step 702. The list is generated according to the number of bidders retrieved in step 702 and represents a random distribution of VQS values. The random distribution may be generated using one of several possible methods such as log-normal, triangular, Pareto, or other method. The list of VQS values vt may be filtered to remove certain outliers (706). In a particular implementation, any VQS value lower than the MRP may be removed from vt. If the number of VQS values remaining in vt is less than a certain threshold, the current simulated auction may be abandoned (706) and control passed to step 718. The threshold may be a number, such as 3, or it may be a certain fixed percentage of the number of bidders, such as 20 % of the number of bidders. For example, if the number of bidders is 100, and all but 19 VQS values are below the MRP, the simulated auction may be abandoned and control of process 700 passed to step 718 to attempt the next simulated auction. The remaining VQS values in vt are then sorted into descending order (710). The descending order of vt may represent the ultimate outcome of an auction.

In a particular implementation of the invention, a CTR may be determined for each VQS value in vt (712) and stored in a list of CTR values ct. CTRs may be calculated using historical bid data structure 816, a reference curve based on a dude state, or some other method. A list of BQS values bt is created by process 700 by determining a BQS value for each VQS value in vt (714). A particular element in vt may be referred to using an index k. Index k may also be used to reference elements in ct and bt. A VQS value may be represented by vtₖ, a BQS value may be represented by btₖ, and a CTR value represented by ctₖ. In a particular implementation, bt₁=vt₁ and all other BQS values in bt are determined by the formula:

$${bt}_{k} = \frac{{vt}_{k} ( {CTR}_{k - 1} - {CTR}_{k} ) + ( {CTR}_{k} \cdot MRP )}{{CTR}_{k - 1}}$$

See Edelman, B., Ostrovsky, M., and Schwarz, M., Internet Advertising and the Generalized Second-Price Auction: Selling Billions of Dollars Worth of Keywords, American Economic Review, Volume 97, March 2007 for further details on calculating a bid times quality score.

In a particular implementation, once all BQS values have been calculated, process 700 calculates a mean BQS added to a list of mean BQS values mbt and a BQS standard deviation added to a list of BQS standard deviation values sbt (716). If process 700 has not yet completed processing simulated auctions for the current VQS distribution, control is returned (718) to step 704. If simulated auctions for the VQS distribution is complete, process 700 calculates the average mean BQS mbqs and average BQS standard deviation sbqs by averaging the values in mbt and sbt, respectively (720). Process 700 then stores mbqs and sbqs in mapping data structure 414. If there are still VQS distributions left to process from mapping data structure 414, control is passed back to step 702. Otherwise, process 700 terminates.

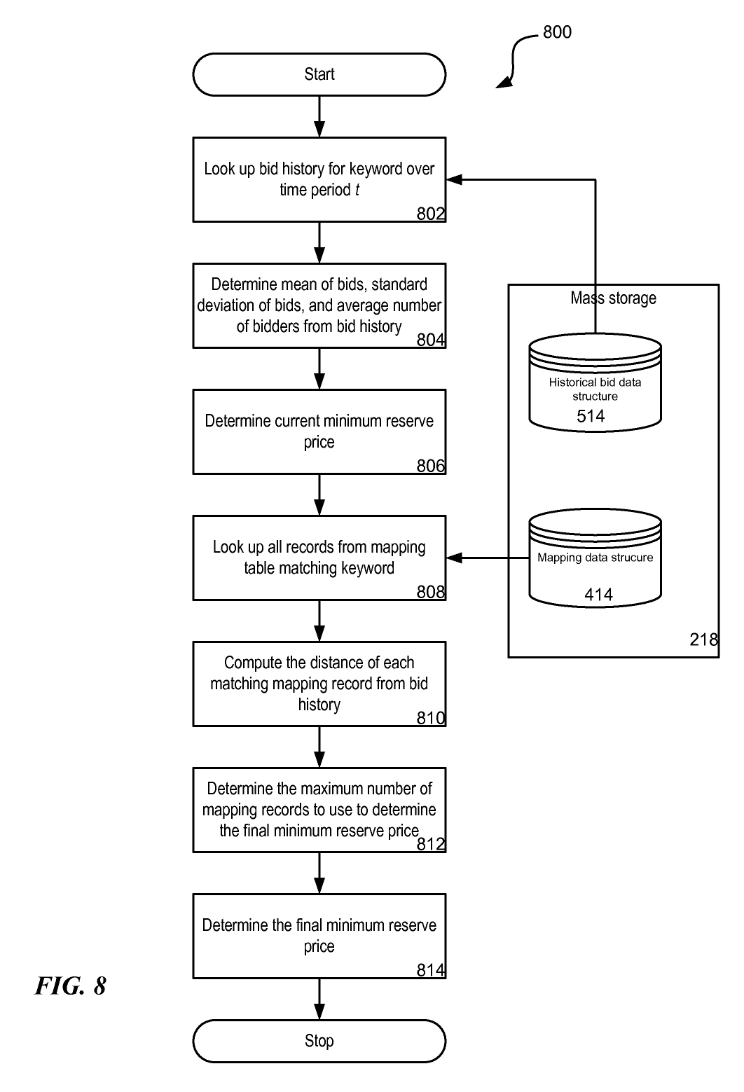

FIG. 8 illustrates an example process 800 that can be implemented by server host 120 to determine the final minimum reserve price fMRP for an auction. In a particular implementation, process 800 begins by searching bid history table 514 for a particular keyword (802). A predetermined time span t may be used to limit the search of bid history table 514. For example, time span t may represent one day, one week, or some other time span. Process 800 continues by computing the historical mean, or average, bid amount hmb, standard deviation of the bid amounts hsb, and the mean, or average, number of bidders hmnb for the data returned by the search in step 804, and determines a current minimum reserve price (806). In one implementation, the current minimum reserve price cMRP is the result of the previous iteration of setting a minimum reserve price related to the keyword using the methods described herein. Initially, the first instance of the minimum reserve price for a given keyword, prior to executing an instance of the method described herein, may be set to a default value or determined by another process. If the lowest bid amount hmb, is higher than the current minimum reserve price cMRP by some predetermined range, then additional bids may be implied. In a particular implementation, implied bids may be generated by one or more methods such as a random or linear distribution of bids between the lowest bid amount hmb and the current minimum reserve price cMRP.

In a particular implementation, process 800 looks up all records in mapping data structure 414 matching the keyword (808). Using mean BQS mbqs, BQS standard deviation sbqs, number of bidders snb, and MRP omrp from mapping data structure 414, process 800 may compute a distance d (810) for each matching record found by step 808 in mapping data structure 414 according to the following formula:

$${d}_{i} = \sqrt{{( 1 - \frac{{mbqs}_{i}}{hmb} )}^{2} + {( 1 - \frac{{sbqs}_{i}}{hsb} )}^{2} + {( 1 - \frac{{snb}_{i}}{hmnb} )}^{2} + {( 1 - \frac{{omrp}_{i}}{cMRP} )}^{2}}$$

One or more matching records from mapping data structure 414 may be used to calculate the final minimum reserve price fMRP. A maximum number of matching records m is calculated to be the minimum of the number of matching records found in step 808 and some predetermined value, such as 5 (812). In a particular implementation, the m records corresponding to the smallest distances d may be used to calculate the final minimum reserve price fMRP. The final minimum reserve price fMRP may be calculated according to the following formula (814):

$$fMRP = \frac{\frac{{omrp}_{0}}{{d}_{0}} + \frac{{omrp}_{1}}{{d}_{1}} + … + \frac{{omrp}_{m - 1}}{{d}_{m - 1}}}{m}$$

In a particular implementation, once the final minimum reserve price fMRP is calculated, process 800 terminates. The final minimum reserve price fMRP may be used as the minimum allowable bid in an auction for search engine advertising placement for a particular keyword.

Other implementations of the invention are also possible. For example, further optimizations may allow processes 400, 500, 600, 700, and 800 to execute in real time. The present invention has been explained with reference to specific embodiments. Other embodiments will be evident to those of ordinary skill in the art. It is therefore not intended that the present invention be limited, except as indicated by the appended claims.

What is claimed is:

1. A method for determining an optimal minimum reserve price for a keyword in online auctions comprising:
generating a historical bid times quality score distribution and historical number of bidders, based on a historical bid data structure comprising a plurality of historical bids;
determining a current minimum reserve price;
searching for one or more bid times quality score distributions in a mapping data structure, the one or more bid times quality distributions associated with a number of bidders and a minimum reserve price; and
determining an optimal minimum reserve price.

2. The method of claim 1 wherein the historical bid times quality score distribution is calculated from the plurality of historical bids encompassing a predetermined time span.

3. The method of claim 2 wherein a plurality of simulated historical bids are interpolated into the plurality of historical bids when the lowest historical bid in the plurality of historical bids is higher than the current minimum reserve price.

4. The method of claim 3 wherein the historical bid times quality score distribution comprises the mean of the plurality of bids together with the standard deviation of the plurality of historical bids.

5. The method of claim 1 wherein a plurality of distances are calculated from the historical bid times quality score distribution, historical number of bidders, and current minimum reserve price to the one or more bid times quality score distributions, number of bidders, and minimum reserve prices.

6. The method of claim 5 wherein a predetermined maximum number of the one or more bid times quality score distributions, number of bidders, and minimum reserve prices are used to determine the optimal minimum reserve price according to the plurality of distances.

7. The method of claim 6 wherein the optimal minimum reserve price is calculated as the average of the inverse distance weighted minimum reserve prices.

8. An apparatus comprising:
a memory;
a network interface;
a processor; and
a server module, stored on a storage medium, comprising computer-readable instructions operative to cause a processor to:
generate a historical bid times quality score distribution and historical number of bidders, based on a historical bid data structure comprising a plurality of historical bids;
determine a current minimum reserve price;
search for one or more bid times quality score distributions in a mapping data structure, the one or more bid times quality distributions associated with a number of bidders and a minimum reserve price; and
determine an optimal minimum reserve price.

9. The apparatus of claim 8, the server host configured to calculate the historical bid times quality score distribution from the plurality of historical bids encompassing a predetermined time span.

10. The apparatus of claim 9, the server host configured to interpolate a plurality of simulated historical bids into the plurality of historical bids when the lowest historical bid in the plurality of historical bids is higher than the current minimum reserve price.

11. The apparatus of claim 10, the historical bid times quality score distribution comprising the mean of the plurality of bids together with the standard deviation of the plurality of historical bids.

12. The apparatus of claim 8, the server host configured to calculate a plurality of distances from the historical bid times quality score distribution, historical number of bidders, and current minimum reserve price to the one or more bid times quality score distributions, number of bidders, and minimum reserve prices.

13. The apparatus of claim 12, the server host configured to use a predetermined maximum number of the one or more bid times quality score distributions, number of bidders, and minimum reserve prices to determine the optimal minimum reserve price according to the plurality of distances.

14. The apparatus of claim 13, the server host configured to calculate the optimal minimum reserve price as the average of the inverse distance weighted minimum reserve prices.

15. Logic for determining an optimal minimum reserve price for a keyword in online auctions, the logic embodied in a computer-readable storage medium and operable to:
generate a historical bid times quality score distribution and historical number of bidders, based on a historical bid data structure comprising a plurality of historical bids;
determine a current minimum reserve price;
search for one or more bid times quality score distributions in a mapping data structure, the one or more bid times quality distributions associated with a number of bidders and a minimum reserve price; and
determine an optimal minimum reserve price.
